(19) United States
(12) Patent Application Publication
(10) Pub. No.: US 2012/0035749 A1
(43) Pub. Date: Feb. 9, 2012

(54) SEAMLESS INTEGRATION OF PROCESS CONTROL DEVICES IN A PROCESS CONTROL ENVIRONMENT

(75) Inventors: Duncan Schleiss, Austin, TX (US); Cindy A. Scott, Georgetown, TX (US); Mark J. Nixon, Round Rock, TX (US)

(73) Assignee: FISHER-ROSEMOUNT SYSTEMS, INC., Austin, TX (US)

(21) Appl. No.: 12/849,928

(22) Filed: Aug. 4, 2010

(51) Int. Cl. G05B 9/02

(52) U.S. Cl. 700/79

(57) ABSTRACT

In order to facilitate seamless integration of process control devices in a process control system, an integrated seamless diagnostic device collects diagnostic data related to the operation of (or problems associated with) one communication link that supports one process control protocol but communicates the collected diagnostic data to other entities in the process control system via another communication link that supports a different process control protocol. As a result, problems with the communication link monitored by the integrated seamless diagnostic device can be reported to the appropriate entities in the process control system as they occur and without unwanted delay. Moreover, problems with the monitored communication link can be communicated to the appropriate entities via process control protocols that are understood by those entities (and other entities in the process control system) and without consuming the potentially valuable resources of the monitored communication link.

### FIELD OF DISCLOSURE

The present disclosure relates generally to process control systems and, more particularly, to seamless integration of process control devices of various different protocol types in a process control systems.

### DESCRIPTION OF THE RELEVANT ART

Process control systems, like those used in chemical, petroleum or other process plant environments, typically include one or more process controllers communicatively coupled to at least one host or operator workstation and to one or more process control and instrumentation devices such as, for example, field devices, via analog, digital or combined communication links. Generally, field devices, which may be, for example, valves, valve positioners, switches, transmitters, and sensors (e.g., temperature, pressure, and flow rate sensors), are located within the process plant environment, and perform functions within the process such as opening or closing valves, measuring process parameters, increasing or decreasing fluid flow, etc. Additionally, “smart” field devices that have computational capabilities, such as field devices conforming to the well-known FOUNDATION™ Fieldbus (hereinafter “Fieldbus”) process control protocol or the Highway Addressable Remote Transducer (HART™) process control protocol may also perform control calculations, alarming functions, and other control functions commonly implemented within the process controller.

As is known, various problems may arise within a process control system that generally result in suboptimal performance of the process plant (e.g., broken or malfunctioning devices, faulty wiring, etc.), and various diagnostic techniques have been developed to detect and correct such problems. For example, many smart devices, such as the FieldVue™ and ValveLink® devices made by Fisher Controls International LLC, have self-diagnostic capabilities that can be used to detect certain problems within those devices. Many of these smart devices also have self-calibration procedures that can be used to correct problems, once detected. In addition, in the event that the detected problem is not easily fixable, some smart devices are able to send alarms, or other signals, to controllers and/or host or operator workstations to indicate that the device is in need of calibration, repair, etc.

However, while many smart field devices are capable of detecting and reporting errors, events, etc. that are associated with the smart field devices themselves, they typically do not diagnose problems associated with the physical networks that interconnect them. For example, smart field devices are generally not capable of diagnosing problems with the physical layer of the communication links (e.g., digital busses) to which the smart field devices are coupled. Such problems include, for example, installation-related problems, such as wiring errors (e.g., open or short circuits, intermittent connections, reversed polarity, and so on), faulty out-of-the-box physical layer components of instruments, inadequate grounding (e.g., multiple grounds in the field, or absence of any clear grounding strategy), etc. Such problems also include post-installation problems, such as environmental degradations, e.g., due to water, exposure of components to excessive light and/or vibration, surge damages resulting from lightning or on-site welding, damages resulting from electrical noise, in-service failure of physical layer components, and so on. Moreover, in many cases, the measurement that the device is making includes process noise, which can lead to increased process variability. Such problems occur due to noisy flow signals, levels signals, and the like.

In order to detect and fix physical-layer issues associated with a communication link in a process control system, various stand-alone diagnostic devices, such as handheld field maintenance and diagnostic devices and in-loop diagnostic devices, have been developed. However, as will be described below in more detail, these conventional diagnostic devices are difficult to integrate into the process control system, and may consume valuable resources of the process control system, thus interfering with its normal operations. As a result, these conventional diagnostic devices often adversely affect the performance of the process control system.

### SUMMARY

In order to facilitate seamless integration of process control devices in a process control system, an integrated seamless diagnostic device and an integrated seamless interface device are provided. In some embodiments, an integrated seamless diagnostic device collects diagnostic data related to the operation of (or problems associated with) one communication link that supports one process control protocol but communicates the collected diagnostic data to other entities in the process control system via another communication link that supports a different process control protocol. As a result, problems with the communication link monitored by the integrated seamless diagnostic device can be reported to the appropriate entities in the process control system as they occur and without unwanted delay. Moreover, problems with the monitored communication link can be communicated to the appropriate entities via process control protocols that are understood by those entities (and other entities in the process control system) and without consuming the potentially valuable resources of the monitored communication link.

In some embodiments, an integrated seamless interface device is used to collect process control information related to a measurement or a control of a physical process parameter via one communication link, and using one process control protocol, and to communicate the collected process control information to other entities in the process control system via another communication link that supports a different process control protocol. For example, process control information may be collected using WirelessHART™ field devices and may be communicated, e.g., to a controller, via a Fieldbus digital bus (or a Profibus link). As a result, the integrated seamless interface device may allow existing process control systems that have Fieldbus networks (or Profibus networks) to effectively take advantage of WirelessHART™ with minimal or no change to the structure of the process control system. It is also possible to apply power spectrum techniques to this data to identify process noise, which if not addressed, leads to increased process variability. Having this capability integrated into the interface device provides a mechanism to track and to detect problems as process conditions change.

### BRIEF DESCRIPTION OF THE DRAWINGS

FIG. 1 is a block diagram illustrating an example of a typical process control system;

FIG. 2 is a block diagram illustrating an example process control system that utilizes the WirelessHART™ process control protocol to provide integrated seamless diagnostics of a communication link in the process control system;

FIG. 3 is a block diagram illustrating an example process control system that utilizes the HART® process control protocol to provide integrated seamless diagnostics of a communication link in the process control system;

FIG. 4 is a block diagram illustrating an example process control system that utilizes the HART® process control protocol in combination with the WirelessHART™ process control protocol to provide integrated seamless diagnostics of a communication link in the process control system;

FIG. 5 is a block diagram illustrating an example WirelessHART™ network;

FIG. 6 is a block diagram illustrating an example process control system that has capabilities to perform integrated seamless diagnostics on a Fieldbus digital bus;

FIG. 7 is a block diagram illustrating and example architecture of an integrated seamless diagnostic device;

FIG. 8 is a flow chart illustrating an example diagnostic method for use in a process control system;

FIG. 9 is a block diagram illustrating an example process control system that integrates different field devices that use different process control protocols;

FIG. 10 is a block diagram illustrating an example architecture of an integrated seamless interface device; and

FIG. 11 a timing diagram illustrating an example mapping of parameters between the Fieldbus and the WirelessHART™ protocols.

Like reference numbers and designations in the various drawings indicate like elements.

### DETAILED DESCRIPTION

Example methods, devices and systems that may provide integrated seamless diagnostics are discussed in detail below. However, before discussing such example methods, devices and systems, it is helpful to provide more details regarding typical process control systems and conventional diagnostic devices.

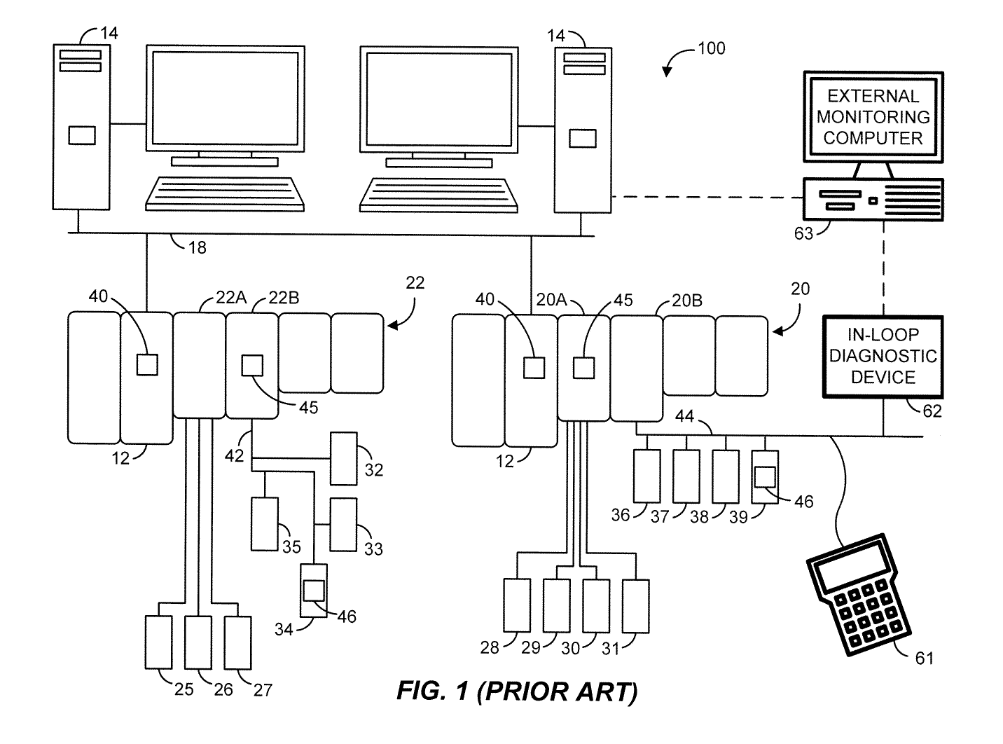

FIG. 1 illustrates a typical process control system 100 used, for example, in chemical, petroleum or other process plant environments. The process control system 10 includes one or more process controllers 12 coupled to one or more host workstations or computers 14 (which may be any type of personal computer, workstation or other computer) via a communication connection 18. The communication connection 18 may be, for example, an Ethernet communication network or any other desired type of private or public communication network. Each of the controllers 12 is coupled to one or more input/output (I/O) devices 20, 22 each of which, in turn, is coupled to one or more field devices 25-39. While two controllers 12 are illustrated in FIG. 1 as connected to fifteen field devices 25-39, the process control system 10 could include any other number of controllers and any desired number and types of field devices. Of course, the controllers 12 may be communicatively coupled to the field devices 25-39 using any desired hardware and software associated with, for example, standard 4-20 ma devices and/or any process control protocol.

As used herein, the phrase “process control protocol” is defined as an industrial automation protocol that is designed to interact with devices in a process control environment in a standardized way and includes specific mechanisms for communicating process control information (e.g., commands for calibrating a field device and/or retrieving the operation of a field device, mechanisms for polling for and/or communicating process variables or measurements, and so on). Example process control protocols include the Fieldbus, Profibus, HART®, WirelessHART™ and ISA wireless protocols.

With continued reference to FIG. 1, as is generally known, the controllers 12, which may be, by way of example only, DeltaV™ controllers sold by Fisher-Rosemount Systems, Inc., implement or oversee process control routines or control modules 40 stored therein or otherwise associated therewith and communicate with the devices 25-39 to control a process in any desired manner. The field devices 25-39 may be any types of devices, such as sensors, valves, transmitters, positioners, etc., while the I/O cards 20 and 22 may be any types of I/O devices conforming to any desired process control protocol. In the example process control system 100 illustrated in FIG. 1, the field devices 25-27 are standard 4-20 ma devices that communicate over analog lines to the I/O card 22A. The field devices 28-31 are illustrated as HART® devices connected to a HART® compatible I/O device 20A. Similarly, the field devices 32-39 are smart devices, such as Fieldbus field devices, that communicate over digital bus 42 or 44 to the I/O cards 20B or 22B using, for example, Fieldbus protocol communications. Of course, the field devices 25-39 and the I/O cards 20 and 22 can conform to any other desired standard(s) or protocols besides the 4-20 ma, HART® or Fieldbus protocols, including any standards or protocols developed in the future. In a similar manner, each of the controllers 12 implements control modules 40 associated with one or more units or other entities, such as areas within the process plant to perform operations on those units, areas, etc. In some cases, parts of the control modules may be located in and executed by the I/O devices 22 or 20 and the field devices 25-39. This is particularly the case with FOUNDATION® Fieldbus field devices 32-39. Modules or portions of modules 45 are illustrated as being located in the I/O cards 20A, 22B and modules or portions of modules 46 are illustrated as being located in the field devices 34 and 39.

Typically, each of the modules 40, 45 and 46 is made up on one or more interconnected function blocks, where each function block is a part (e.g., a subroutine) of an overall control routine and operates in conjunction with other function blocks (via communications called links) to implement process control loops within the process control system 100. Function blocks typically perform one of an input function, such as that associated with a transmitter, a sensor or other process parameter measurement device, a control function, such as that associated with a control routine that performs PID, fuzzy logic, etc. control, or an output function that controls the operation of some device, such as a valve, to perform some physical function within the process control system 100. Of course hybrid and other types of function blocks exist. Both function blocks and modules may be stored in and executed by the controllers 12, which is typically the case when these function blocks are used for, or are associated with standard 4-20 ma devices and some types of smart field devices, or may be stored in and implemented by the field devices themselves, which may be the case with FOUNDATION® Fieldbus devices. While the description of the process control system 100 is provided herein using function block control strategy, the control strategy could also be implemented or designed using other conventions, such as ladder logic, sequential flow charts, etc. and using any desired proprietary or non-proprietary programming language.

As explained above, problems may arise within the process control system 100 that may result in suboptimal performance of the process plant (e.g., broken or malfunctioning devices, faulty wiring, etc.). In particular, there may arise problems with the various communication links (e.g., digital bus 44) within the process control system 100. Such problems include, for example, installation-related problems, such as wiring errors (e.g., open or short circuits, intermittent connections, reversed polarity, and so on), faulty out-of-the-box physical layer components of instruments, inadequate grounding (e.g., multiple grounds in the field, or absence of any clear grounding strategy), etc. Such problems also include post-installation problems, such as environmental degradations, e.g., due to water, exposure of components to too much light and/or vibration, surge damages resulting from lightning or on-site welding, damages resulting from electrical noise, in-service failure of physical layer components, and so on.

In order to detect and fix physical layer issues associated with a communication link 44 in the process control system 100, various diagnostic devices have been developed. For example, handheld field maintenance devices, such as the handheld field maintenance device 61 illustrated in FIG. 1, can be wired to a communication link (e.g., a digital bus 44) to detect and diagnose physical layer problems with the link 44. Using a handheld field maintenance device 61, maintenance personnel may be informed of such problems through aural, visual, etc. indicators and alerts provided via the handheld field maintenance device 61. One major drawback of such a handheld field maintenance device 61, however, is that the handheld field maintenance device 61 is only intermittently connected to the digital links (such as the digital bus 44) within the control system 100 and not usually tied into the process control network 100 and, therefore, does not communicate information related to the detected problems to the associated controller 12, operator workstation 14, etc., soon enough for any effective immediate corrective action to take place. As a result, the problems detected by the handheld field maintenance device 61 are usually detected well after the fault occurs and often do not get fixed in a timely manner. Additionally, the handheld field maintenance devices 61 typically require at least some manual user interaction in the field.

To overcome the drawbacks of handheld field maintenance devices, in-loop diagnostic devices or systems, such as the in-loop diagnostic device 62 illustrated in FIG. 1, are sometimes used. Generally, a conventional in-loop diagnostic device 62 is coupled to the communication link 44 that is to be monitored, or diagnosed, and to an external monitoring computer 63 (e.g., a laptop), or another external interface that is tied into the process control network 100. The external monitoring computer 63 runs a diagnostic and/or monitoring application to monitor, or diagnose, the operation of the communication link 44 and to communicate information regarding the operation of the communication link 44 to the associated controllers 12, or operator workstations 14, using Object Linking and Embedding (OLE) for Process Control (OPC). As a result, problems may be reported to appropriate entities within the process control system 100 as they occur.

However, although conventional in-loop diagnostic devices 62 have certain advantages over the handheld field maintenance devices 61, in-loop diagnostic devices 62 are nonetheless difficult to integrate into the process control system 100 because of the need for external interfaces, such as the external monitoring computer illustrated in FIG. 1. The additional hardware typically leads to an increase in diagnostics complexity, potentially resulting in more, and/or more expensive processing components and longer processing times. This increase in complexity may also result in more errors and diminished reliability of the diagnostic information.

To overcome these issues, some existing diagnostic devices that monitor and diagnose physical layer problems with the communication links 44 are configured to communicate information regarding those problems to the associated controllers and workstations using the same communication links 44 instead of external interfaces (such as external monitoring computers 63). For instance, some such diagnostic devices (not shown) may be coupled to a particular Fieldbus digital bus 44, detect problems on that digital bus 44, and send data indicative of the problems via that same digital bus 44 (and using the Fieldbus process control protocol) to the associated controllers 12 and workstations 14. Such diagnostics devices may therefore be integrated into the process control network as Fieldbus devices. The drawback of these diagnostic devices, however, is that they consume potentially valuable resources of the Fieldbus digital bus 44 and interfere with the normal operations on the digital bus 44 (e.g., delaying the communication of measurement data over the digital bus 44). Furthermore, such diagnostic devices require an operational Fieldbus digital bus and might, therefore, be incapable of detecting or communicating those problems that render the Fieldbus digital bus inoperative (e.g., power supply failures).

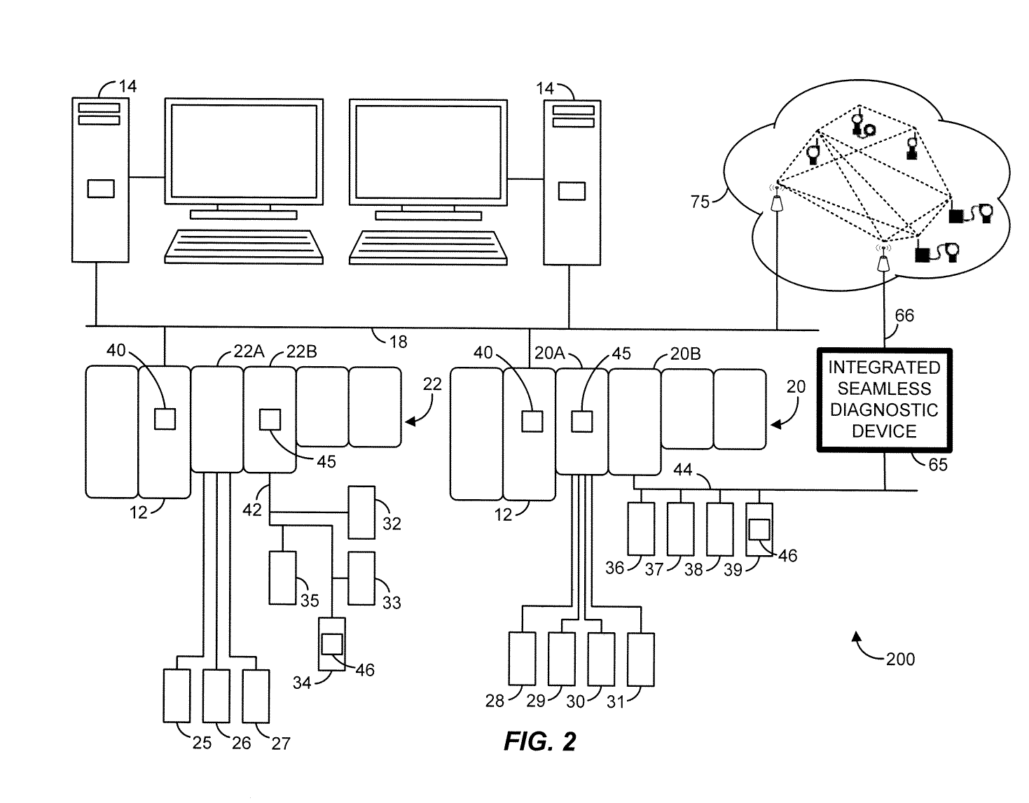

FIG. 2 is a block diagram illustrating an example process control system 200 that includes integrated seamless diagnostic capabilities. In order to facilitate integrated seamless diagnostics, the process control system 200 includes an integrated seamless diagnostic device 65. Generally, the integrated seamless diagnostic device 65 collects diagnostic data related to the operation of (or problems associated with) one communication link 44 that supports one process control protocol but communicates the collected diagnostic data to other entities in the process control system 200 via another communication link 66 that supports a different process control protocol. As a result, problems with the communication link 44 monitored by the integrated seamless diagnostic device 65 can be reported to the appropriate entities in the process control system 200 as they occur and without unwanted delay. Moreover, problems with the monitored communication link 44 can be communicated to the appropriate entities via process control protocols that are understood by those entities (and other entities in the process control system 200) and without consuming the potentially valuable resources of the monitored communication link 44 itself.

In the embodiment illustrated in FIG. 2, the process control system 200 utilizes the WirelessHART™ process control protocol to provide integrated seamless diagnostics of a communication link that supports the Fieldbus process control protocol. That is, the integrated seamless diagnostic device 65 collects diagnostic data related to the operation of (or problems associated with) a communication link 44 that supports the Fieldbus process control protocol and communicates the collected diagnostic data to other entities in the process control system 200 via a communication link 66 that supports the WirelessHART™ process control protocol. As a result, the integrated seamless diagnostic device 65 may be coupled to a WirelessHART™ network 75 and communicate the collected diagnostic data via the WirelessHART™ network 75.

In this and similar embodiments, the integrated seamless diagnostic device 65 can be defined as a standard WirelessHART™ field device using a suitable description language (DDL) and/or device description service (DDS). For example, the Electronic Device Descriptor Language (EDDL) may be used. As a result, from the perspective of the various entities in the process control system 200, the integrated seamless diagnostic device 65 may function as a standard smart field device, much like other smart field devices 28-39 in the process control system 200, with full configuration, diagnostics and operations support. Defining the integrated seamless diagnostic device 65 using EDDL may further provide a way for future releases of the integrated seamless diagnostic device 65 to add features while at the same time maintaining backward compatibility with previous tools and applications.

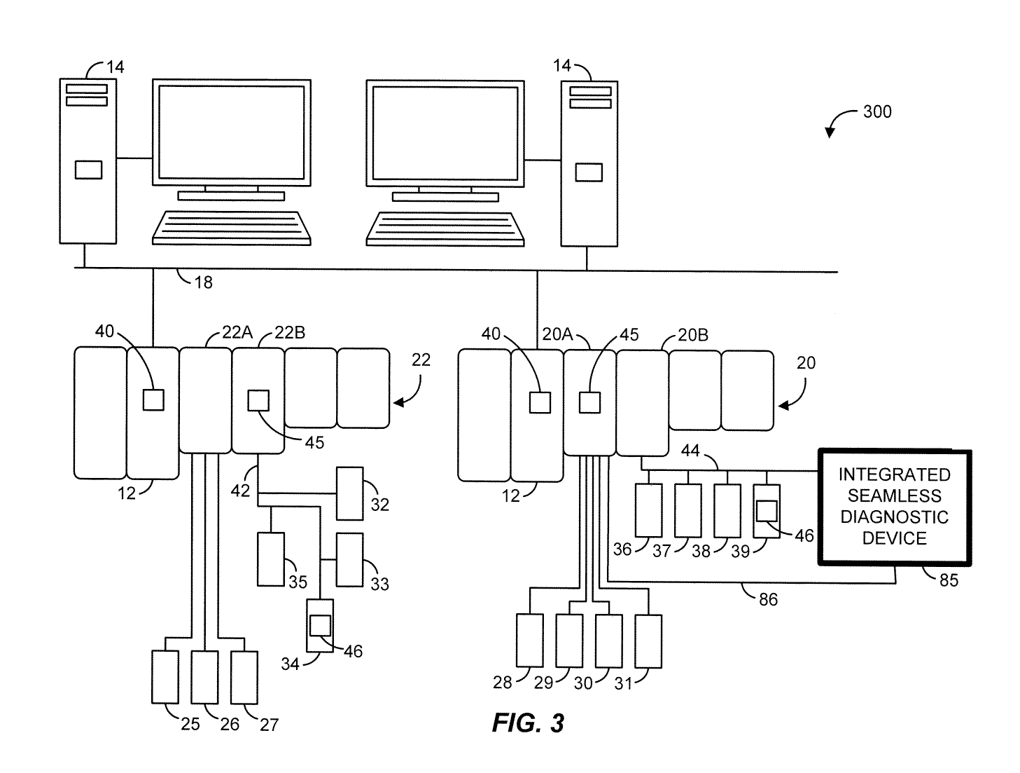

FIG. 3 is a block diagram illustrating an example process control system 300 that utilizes the HART® process control protocol to provide integrated seamless diagnostics of a communication link that supports the Fieldbus process control protocol. The process control system 300 of FIG. 3 includes an integrated seamless diagnostic device 85 that collects diagnostic data related to the operation of (or problems associated with) a communication link 44 that supports the Fieldbus process control protocol and communicates the collected diagnostic data to other entities in the process control system 300 via a communication link 86 that supports the HART® process control protocol. As a result, the integrated seamless diagnostic device 85 may be coupled to a HART® compatible I/O device, such as the HART® compatible I/O device 20A described in reference to FIG. 1. In this and similar embodiments, the integrated seamless diagnostic device 85 can be defined as a standard HART™ device using, for example, EDDL.

Before continuing the discussion of integrated seamless diagnostics, it is helpful to provide more details regarding DDL and DDS. Generally, DDL is a human-readable language that provides a protocol for describing the data available from a smart device, the meaning of the data associated with the smart device and retrieved therefrom, the methods available for implementation of the smart device, the format for communicating with the smart device to obtain data, user interface information about the device (such as edit displays and menus), and data necessary for handling or interpreting other information pertaining to a smart device.

DDL source files typically include human-readable text written by device developers. These files specify all the information available about a device between the device and a communication link (e.g., a bus) or a host to which the device is connected. Generally, in developing a DDL source file for a device, a developer uses the DDL language to describe core or essential parameter characteristics of the device as well as to provide group-specific, and vendor-specific definitions relating to each block, parameter, and special feature of a smart device.

A DDL source file is typically compiled into a binary format to produce a machine-readable file known as a device description (DD) which can be provided to a user by the device manufacturer or a third-party developer to be stored in a host system, such as a management system. In some cases, for example, in Fieldbus devices, DDL source files may be stored in a smart device and transferred from the smart device to a host system. When the host system receives a DD object file for a smart device, it can decode and interpret the DD to derive a complete description of the interface with the device.

DDS is a general software system developed and provided by Fisher-Rosemount Systems, Inc. and/or Rosemount, Inc. for automatically decoding and interpreting the DD's of smart devices. More particularly, DDS is a library of routines which, when called by a host, interprets the DD of a smart device to provide the host with information pertaining to the smart device, including information pertaining to: (1) the setup and configuration of the smart device; (2) communication with the smart device; (3) user interfaces; and (4) methods available for use in conjunction with the smart device. One extremely useful application of DDS is in providing a consistent interface between a host system and one or more smart devices having associated DDL source files (and corresponding DD object files).

Although DDS, DDL and DD's are generally known in the art, more information pertaining to the specific function and format of DDL's, and of Fieldbus DDL in particular, can be found in the InterOperable Systems Project Foundation's manual entitled “InterOperable Systems Project Fieldbus Specification Device Description Language” (1993), which is hereby incorporated by reference herein. A similar document pertaining to the HART DDL is provided by the HART communication foundation.

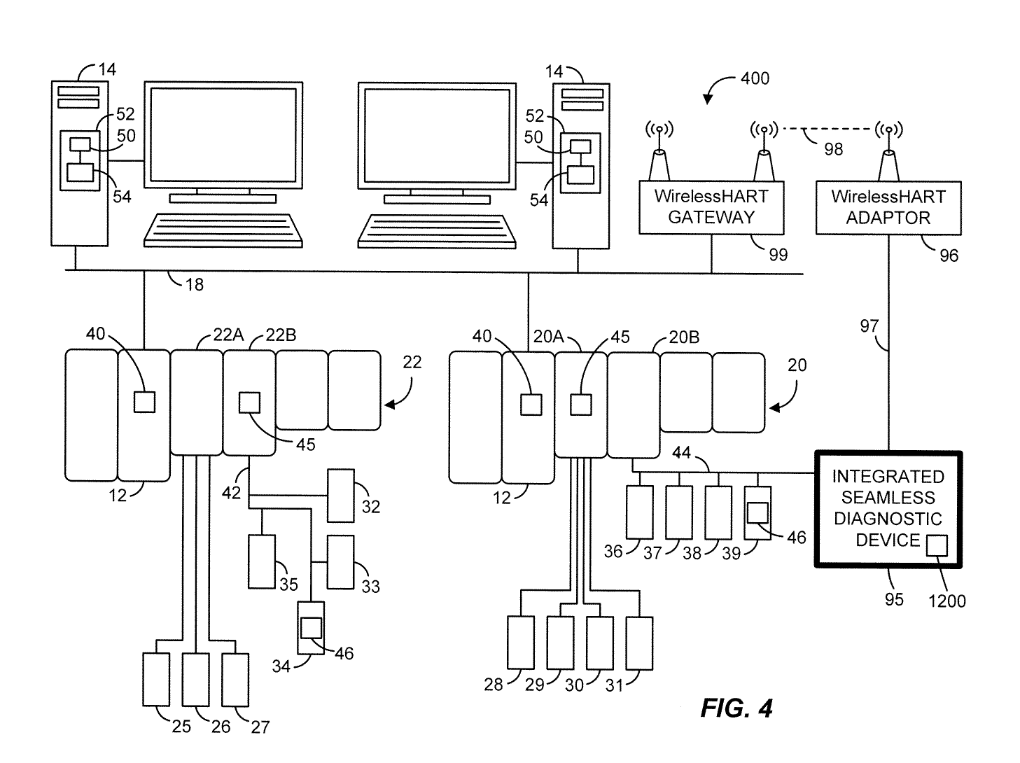

Referring again to FIG. 2 and FIG. 3, although the process control system 200 of FIG. 2 utilizes the WirelessHART™ process control protocol and the process control system 300 of FIG. 3 utilizes the HART® protocol, it will be appreciated by one of ordinary skill in the art that a combination of HART® and WirelessHART™ may also be utilized to provide integrated seamless diagnostics. For example, FIG. 4. is a block diagram illustrating an example process control system 400 that utilizes the HART® process control protocol and the WirelessHART™ process control protocol to provide integrated seamless diagnostics of a communication link that supports the Fieldbus process control protocol. The process control system 400 of FIG. 4 includes an integrated seamless diagnostic device 95 that collects diagnostic data related to the operation of (or problems associated with) a communication link 44 that supports the Fieldbus process control protocol and communicates the collected diagnostic data to other entities in the process control system 400 using a combination of the HART® process control protocol and the WirelessHART™ protocol. For example, the integrated seamless diagnostic device 95 can be defined as a standard HART® device using, for example, EDDL. Additionally, the integrated seamless diagnostic device 95 may be communicatively coupled to a WirelessHART™ adaptor 95 via a wired link (or a wired network) 97, and the WirelessHART™ adaptor 95 may, in turn, be communicatively coupled, via a WirelessHART™ link (or network) 98 to a WirelessHART™ gateway 99. The WirelessHART™ gateway 99 may be communicatively coupled to an Ethernet communication network, for example, such as the Ethernet communication network 18 described in reference to FIG. 1.

It should be understood that the HART® process control protocol and devices and the WirelessHART™ process control protocol and devices may be used in various combinations other than that illustrated in FIG. 4 in order to provide integrated seamless diagnostics of a communication link in a process control system. Although it would be impractical, if not impossible, to describe every possible combination, the following discussion of the WirelessHART™ process control protocol will help one of ordinary skill in the art to design some such combinations without departing from the scope of this disclosure. It should be understood, however, that the WirelessHART™ protocol is known in the art and is described in detail in numerous articles, brochures and specifications published, distributed, and available from, among others, the HART Communication Foundation, a not-for-profit organization headquartered in Austin, Tex.

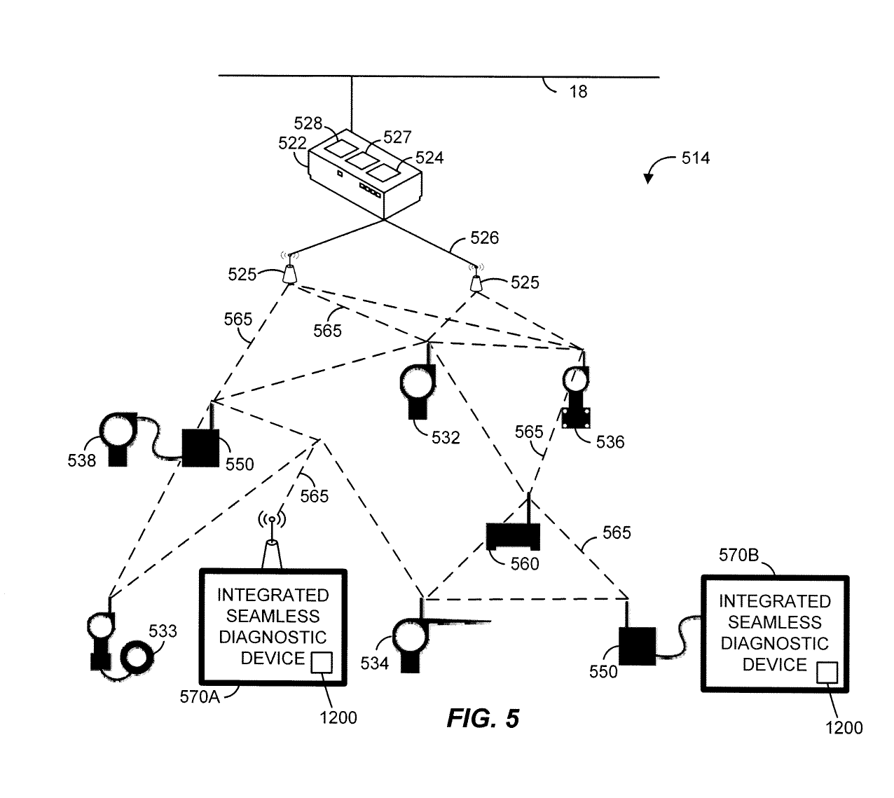

FIG. 5 is a block diagram illustrating an example WirelessHART™ network 514. In some embodiments, the example WirelessHART™ network 514 may be used as the WirelessHART™ network 75 in the process control system 200 of FIG. 2. Therefore, for ease of explanation, the WirelessHART™ network 514 will be described in reference to FIG. 2. However, it will be understood that the process control system 200 of FIG. 2 may utilize a WirelessHART™ network 75 that is different from the WirelessHART™ network 514 illustrated in FIG. 5. Likewise, it will be understood that the WirelessHART™ network 514 may be used with devices and systems other than those illustrated in FIG. 2.

The WirelessHART™ network 514 may be coupled to the Ethernet communication network 18 of the process control system 200 via a gateway 522. The gateway 522 may be implemented as a standalone device, as a card insertable into an expansion slot of the hosts or workstations 14, or as part of the IO subsystem of a PLC-based or DCS-based system, or in any other manner. The gateway 522 provides applications running in the process control system 200 access to various devices of the WirelessHART™ network 514. In addition to protocol and command conversion, the gateway 522 may provide synchronized clocking used by time slots and superframes (sets of communication time slots spaced equally in time) of the scheduling scheme of the WirelessHART™ network 514. In some embodiments that gateway 522 illustrated in FIG. 5 may be similar to the WirelessHART™ gateway 99 illustrated in FIG. 4.

In some situations, networks may have more than one gateway 522. In this case the gateways are treated as redundant or backup devices. In addition, as shown in FIG. 5, the network 514 may have more than one network access point 525. These multiple access points 525 can be used to improve the effective throughput and reliability of the network by providing additional bandwidth for the communication between the WirelessHART™ network and the process control system 200 or the outside world. On the other hand, the gateway device 522 may request bandwidth from the appropriate network service according to the gateway communication needs within the WirelessHART™ network. The gateway 522 may further reassess the necessary bandwidth while the system is operational. For example, the gateway 522 may receive a request from a host residing outside the WirelessHART™ network 514 to retrieve a large amount of data. The gateway device 522 may then request additional bandwidth from a dedicated service such as a network manager in order to accommodate this transaction. The gateway 522 may then request the release of the unnecessary bandwidth upon completion of the transaction.

In some embodiments, the gateway 522 is functionally divided into a virtual gateway 524 and one or more network access points 525. Network access points 525 may be separate physical devices in wired communication with the gateway 522 in order to increase the bandwidth and the overall reliability of the WirelessHART™ network 514. However, while FIG. 5 illustrates a wired connection 526 between the physically separate gateway 522 and access points 525, it will be understood that the elements 522-526 may also be provided as an integral device. Because network access points 525 may be physically separate from the gateway device 522, the access points 525 may be strategically placed in several distinct locations. In addition to increasing the bandwidth, multiple access points 525 can increase the overall reliability of the network by compensating for a potentially poor signal quality at one access point at one or more other access points. Having multiple access points 525 also provides redundancy in case of failure at one or more of the access points 525.

The gateway 522 may additionally contain a network manager software module 527 and a security manager software module 528. In another embodiment, the network manager 527 and/or the security manager 528 may run on one of the hosts 14 in the process control system 200. The network manager 527 may be responsible for configuration of the network, scheduling communication between WirelessHART™ field devices (i.e., configuring superframes), management of the routing tables and monitoring and reporting the health of the WirelessHART™ network 514. While redundant network managers 527 are supported, it is contemplated that there should be only one active network manager 527 per WirelessHART™ network 514. It should also be understood that a network manager 527 can span more than one WirelessHART network 514.

Referring again to FIG. 5, the WirelessHART™ network 514 may include one or more field devices 530-538. As explained above, in general, process control systems include such field devices as valves, valve positioners, switches, sensors (e.g., temperature, pressure and flow rate sensors), pumps, fans, etc. for performing control functions within the process such as opening or closing valves and taking measurements of process parameters. In the WirelessHART™ communication network 514, field devices 530-538 are producers and consumers of WirelessHART™ packets.

The WirelessHART™ network 514 may use a process control protocol that provides similar operational performance that is experienced with wired HART® devices, such as the wired HART® devices 28-31 illustrated in FIG. 2. The applications of this protocol may include process data monitoring, critical data monitoring (with the more stringent performance requirements), calibration, device status and diagnostic monitoring, field device troubleshooting, commissioning, and supervisory process control. These applications require that the WirelessHART™ network 514 use a protocol that can provide fast updates when necessary, moves large amounts of data when required, and supports network devices which join the WirelessHART™ network 514 only temporarily for commissioning and maintenance work.

In one embodiment, the wireless protocol supporting network devices of the WirelessHART™ network 514 is an extension of HART®, a widely accepted industry standard, that maintains the simple workflow and practices of the wired environment. In accordance with this embodiment, the same tools used for wired HART® devices may be easily adapted to wireless devices with the simple addition of new device description files. In this manner, the WirelessHART™ protocol leverages the experience and knowledge gained using HART® to minimize training and simplify maintenance and support. Generally speaking, it may be convenient to adapt a protocol for wireless use so that most applications running on a device do not “notice” the transition from a wired network to a wireless network. Clearly, such transparency greatly reduces the cost of upgrading networks and, more generally, developing and supporting devices that may be used with such networks. Some of the additional benefits of a wireless extension of HART® include providing access to measurements that were difficult or expensive to get to with wired devices, providing the ability to configure and operate instruments from system software that can be installed on laptops, handhelds, workstations, etc. Another benefit is the ability to send diagnostic alerts from wireless devices back through the various communication techniques to a centrally located diagnostic center. For example, every heat exchanger could be fitted with a WirelessHART™ field device and the end user and supplier could be alerted when the heat exchanger detects a problem. Yet another benefit is the ability to monitor conditions that present serious health and safety problems. For example, a WirelessHART™ field device could be placed in flood zones on roads and used to alert authorities and drivers about water levels. Other benefits include access to wide range of diagnostics alerts and the ability to store trended as well as calculated values at the WirelessHART™ field device so that, when communications to the device are established, the values can be transferred to the host. Thus, a WirelessHART™ protocol can provide technology for host applications to have wireless access to existing HART-enabled field devices and will support the deployment of battery operated, wireless only HART-enabled field devices. The WirelessHART™ protocol may be used to establish a wireless communication standard for process applications and may further extend the application of HART® communications and the benefits it provides to industry by enhancing the HART® technology to support wireless process automation applications.

Referring again to FIG. 5, field devices 530-536 may be WirelessHART™ field devices. In other words, a field device 530, 532, 534, or 536 may be provided as an integral unit supporting all layers of the WirelessHART™ protocol stack. The field device 530 may be a WirelessHART™ flow meter, the field devices 532 may be WirelessHART™ pressure sensors, the field device 534 may be a WirelessHART™ valve positioner, and the field device 536 may a WirelessHART™ pressure sensor. Importantly, WirelessHART™ field devices 530-536 are HART® devices supporting all that users have come to expect from the wired HART® protocol. As one of ordinary skill in the art will appreciate, one of the core strengths of the HART® protocol is its rigorous interoperability requirements. In some embodiments, all WirelessHART™ equipment includes core mandatory capabilities in order to allow equivalent device types to be exchanged without compromising system operation. Furthermore, the WirelessHART™ protocol is backward compatible to HART® core technology such as the device description language (DDL). In the preferred embodiment, all HART® devices should support the DDL, which ensures that end users immediately have the tools to begin utilizing the WirelessHART™ protocol.

On the other hand, a field device 538 may be a legacy 4-20 mA device or a wired HART® device. The field device 538 may be, for example, connected to the WirelessHART™ network 514 via a WirelessHART™ adaptor (WHA) 550, such as the WirelessHART™ adaptor 96 illustrated in FIG. 4. Additionally, the WHA 550 may support other communication protocols such as FOUNDATION® Fieldbus, PROFIBUS, DeviceNet, etc. In these embodiments, the WHA 550 supports protocol translation on a lower layer of the protocol stack. Additionally, it is contemplated that a single WHA 550 may also function as a multiplexer and support multiple HART® or non-HART devices.

Additionally, the WirelessHART™ network 514 may include a router device 560 which is a network device that forwards packets from one network device to another. A network device that is acting as a router device uses internal routing tables to decide to which network device it should forward a particular packet. Stand alone routers such as the router 560 may not be required in those embodiments where all devices on the WirelessHART™ network 514 support routing. However, it may be beneficial (e.g. to extend the network, or to save the power of a field device in the network) to add a dedicated router 560 to the network.

All devices directly connected to the WirelessHART™ network 514 may be referred to as network devices. In particular, the WirelessHART™ field devices 530-536, the adaptors 550, the routers 560, the gateway 522, and the access points 525 are, for the purposes of routing and scheduling, the network devices or the nodes of the WirelessHART™ network 514. In order to provide a very robust and an easily expandable network, it is contemplated that all network devices may support routing and each network device may be globally identified by its HART address. The network manager 527 may contain a complete list of network devices and assign each device a short, network unique 16-bit nickname. Additionally, each network device may store information related to update rates, connections sessions, and device resources. In short, each network device maintains up-to-date information related to routing and scheduling. The network manager 527 communicates this information to network devices whenever new devices join the network or whenever the network manager detects or originates a change in topology or scheduling of the WirelessHART™ network 514.

Further, each network device may store and maintain a list of neighbor devices that the network device has identified during the listening operations. Generally speaking, a neighbor of a network device is another network device of any type potentially capable of establishing a connection with the network device in accordance with the standards imposed by a corresponding network. In case of the WirelessHART™ network 514, the connection is a wireless connection. However, it will be appreciated that a neighboring device may also be a network device connected to the particular device in a wired manner. As will be discussed later, network devices promote their discovery by other network devices through advertisement, or special messages sent out during the designated timeslots. Network devices operatively connected to the WirelessHART™ network 514 have one or more neighbors which they may choose according to the strength of the advertising signal or to some other principle. Referring again to FIG. 5, in a pair of network devices connected by a direct wireless connection 565, each device recognizes the other as a neighbor. Thus, network devices of the WirelessHART™ network 514 may form a large number of connections 565. The possibility and desirability of establishing a direct wireless connection 565 between two network devices is determined by several factors such as the physical distance between the nodes, obstacles between the nodes, signal strength at each of the two nodes, etc. Further, two or more direct wireless connections 565 may form paths between nodes that cannot form a direct wireless connection 565.

Each wireless connection 565 is characterized by a large set of parameters related to the frequency of transmission, the method of access to the radio resource, etc. One of ordinary skill in the art will recognize that, in general, wireless communication protocols may operate on designated frequencies, such as the ones assigned by the Federal Communications Commission (FCC) in the United States, or in the unlicensed part of the radio spectrum (2.4 GHz). While the system and method discussed herein may be applied to a wireless network operating on any designated frequency or range of frequencies, the embodiment discussed below relates to the WirelessHART™ network 514 operating in the unlicensed, or shared part of the radio spectrum. In accordance with this embodiment, the WirelessHART™ network 514 may be easily activated and adjusted to operate in a particular unlicensed frequency range as needed.

For a wireless network protocol using an unlicensed frequency band, coexistence is a core requirement because a wide variety of communication equipment and interference sources may be present. Thus, in order to successfully communicate, devices using a wireless protocol must coexist with other equipment utilizing this band. Coexistence generally defines the ability of one system to perform a task in a given shared environment in which other systems have an ability to perform their tasks, wherein the various systems may or may not be using the same set of rules. One requirement of coexistence in a wireless environment is the ability of the protocol to maintain communication while there is interference present in the environment. Another requirement is that the protocol should cause as little interference and disruption as possible with respect to other communication systems.

In other words, the problem of coexistence of a wireless system with the surrounding wireless environment has two general aspects. The first aspect of coexistence is the manner in which the system affects other systems. For example, an operator or developer of the system may ask what impact the transmitted signal of one transmitter has on other radio systems operating in proximity to the system. More specifically, the operator may ask whether the transmitter disrupts communication of some other wireless device every time the transmitter turns on or whether the transmitter spends excessive time on the air effectively “hogging” the bandwidth. One familiar with wireless communications will agree that ideally, each transmitter should be a “silent neighbor” that no other transmitter notices. While these ideal characteristics are rarely, if ever, attainable, a wireless system that creates a coexistence environment in which other wireless communication systems may operate reasonably well may be called a “good neighbor.” The second aspect of coexistence of a wireless system is the ability of the system to operate reasonably well while other systems or wireless signal sources are present. In particular, the robustness of the system may depend on how well the system prevents interference at the receivers, on whether the receivers easily overload due to proximate sources of RF energy, on how well the receivers tolerate an occasional bit loss, and similar factors. In some industries, including the process control industry, there is a number of important potential applications of a wireless communication system. In these applications, loss of data is frequently not allowable. A wireless system capable of providing reliable communications in a noisy or dynamic radio environment may be called a “tolerant neighbor.”

Coexistence relies (in part) on effectively employing three aspects of freedom: time, frequency and distance. Communication can be successful when it occurs at a 1) time when the interference source (or other communication system) is quiet; 2) different frequency then the interference; or 3) location sufficiently removed from the interference source. While a single one of these factors could be used to provide a communication scheme in the shared part of the radio spectrum, taking into account a combination of two or all three of these factors can provide a high degree of reliability, security and speed.

Integrated seamless diagnostic devices 570A, 570B, such as, or similar to, to integrated seamless diagnostic devices 65, 85, 95 described in reference to FIGS. 1-4 may be coupled to the WirelessHART™ network 514 in a variety of ways. As one example, an integrated seamless diagnostic device 570A that is defined as a WirelessHART™ field device (similar to the integrated seamless diagnostic device 65 of FIG. 2) may be coupled to the WirelessHART™ network 514 in a wireless manner. Additionally, or alternatively, an integrated seamless diagnostic device 570B that is defined as a wired HART® device (similar to the integrated seamless diagnostic device 95 of FIG. 4) may be coupled to the WirelessHART™ network 514 at least partially in a wired manner via a WirelessHART™ adaptor 550.

By way of example, not limitation, integrated seamless diagnostics techniques that have been described in reference to FIGS. 2-4 were considered in reference to diagnosing problems associated with a Fieldbus digital bus. It is therefore helpful to provide more details regarding the Fieldbus protocol, the physical layer associated with this protocol, field devices configured according to this protocol, and the way in which communication occurs in a process control system (such as the process control systems 100-400) that uses the Fieldbus protocol. It should be understood, however, that the Fieldbus protocol is known in the art and is described in detail in numerous articles, brochures and specifications published, distributed, and available from, among others, the Fieldbus Foundation, a not-for-profit organization headquartered in Austin, Tex.

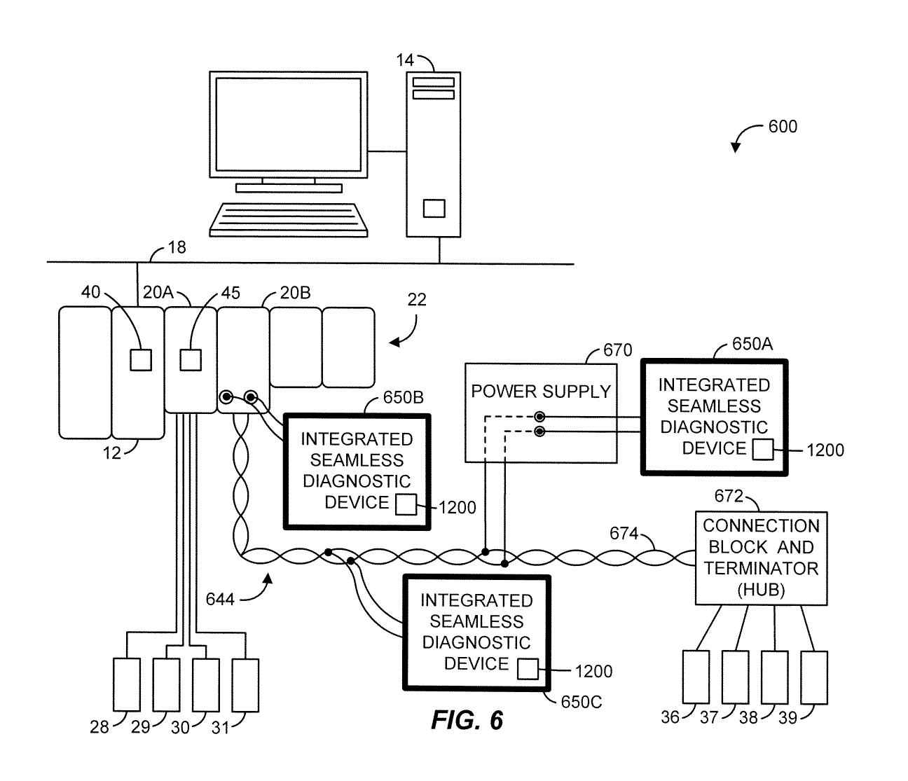

FIG. 6 is a block diagram illustrating an example process control system 600 that has the capability of performing integrated seamless diagnostics on a Fieldbus digital bus 644. The Fieldbus digital bus 644 (which may be similar to the digital bus 44 illustrated in FIGS. 1-4) includes a power supply 70 that delivers power to the Fieldbus digital bus 670. The Fieldbus digital bus 644 further includes a connection block and terminator 672 (also known as a wiring hub, or “hub”) that couples field devices 36-39 to the Fieldbus digital bus 644. Still further, the Fieldbus digital bus 644 includes a physical link 674 that couples the various components of the Fieldbus digital bus 644 (e.g., the power supply 670 and the wiring hub 672) to an I/O device 20B of a Fieldbus controller 12. Although the physical link 674 illustrated in FIG. 6 is a twisted pair, the physical link 674 may also be coaxial cable, a fiber link, and so on.

Integrated seamless diagnostic devices 650A-650C, such as, or similar to, the integrated seamless diagnostic devices 65, 85, 95 illustrated in FIGS. 2-4 may be coupled to the Fieldbus digital bus 644 in a variety of ways. For example, an integrated seamless diagnostic devices 650A may be coupled to the Fieldbus digital bus 644 via the power supply 670. An integrated seamless diagnostic devices 650B may also be coupled to the Fieldbus digital bus 644 via the I/O device 20B. Still further, an integrated seamless diagnostic devices 650C may be coupled to the Fieldbus digital bus 644 via the physical link 674 of the Fieldbus digital bus 644.

The Fieldbus digital bus 644, in some embodiments, or in some modes of operation, may not include one or more of the components discussed above in reference to FIG. 6 or, alternatively, may not use each of the described components. Further, it will be appreciated that some of the described components may be combined or, conversely, divided into smaller components. For example, the power supply 670 may be integrated into the Fieldbus controller 20A. Still further, Fieldbus digital bus 644 may include additional components and/or modules (e.g., repeaters) that, for ease of explanation, are not shown in FIG. 6.

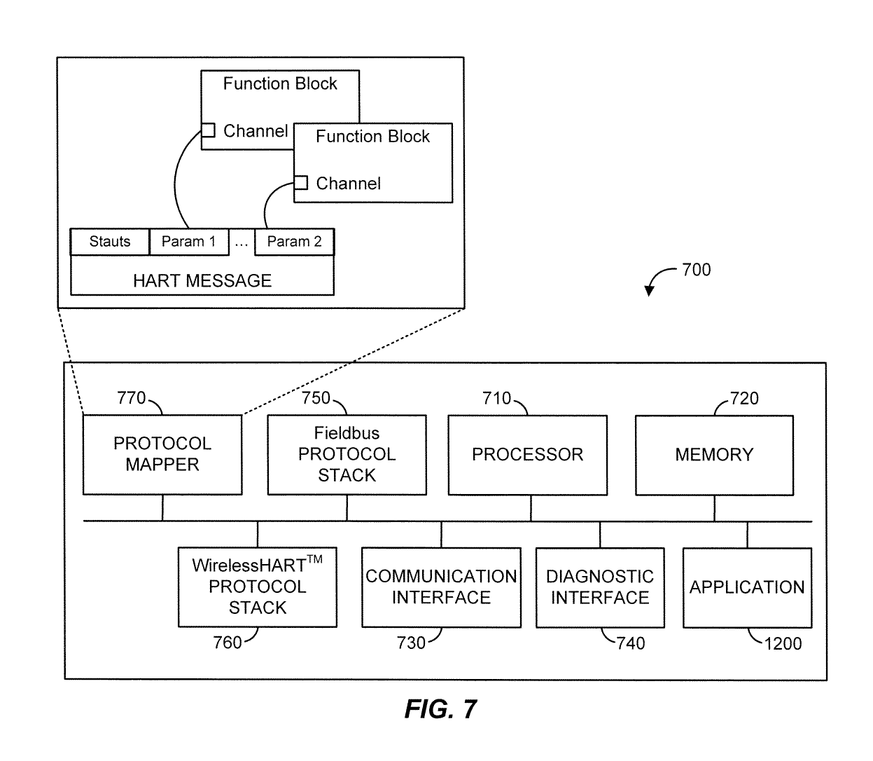

FIG. 7 is a block diagram illustrating an example architecture of an integrated seamless diagnostic device 700. Generally, the integrated seamless diagnostic device 700 includes a diagnostic interface 740 and a communication interface 730. The diagnostic interface 740 is configured to communicatively couple to one communication link (e.g., a Fieldbus digital bus) to collect diagnostic information related to the operation of the first communication link, and the communication interface 730 is configured to communicatively couple to another communication link (e.g., a communication link that supports the HART® or the WirelessHART™ protocol) to communicate data indicative of the collected diagnostic information via that communication link to an entity in the process control system other than the integrated seamless diagnostic device 700.

Depending on the combination of process control protocols used for collecting and communicating diagnostic information, the integrated seamless diagnostic device 700 may include appropriate protocol stacks. For example, if used as the integrated seamless diagnostic device 65 in the embodiment illustrated in FIG. 2, the integrated seamless diagnostic device 700 may include a Fieldbus protocol stack 750 used by the Fieldbus (or Profibus) protocol and also a WirelessHART™ protocol stack 760 used by the WirelessHART™ protocol. The integrated seamless diagnostic device 700 may also include a protocol mapper 770 for providing a mapping (e.g., parameter mapping) between the two process control protocols. In some embodiments, the protocol stack used by the Fieldbus (or Profibus) protocol and the protocol stack used by the WirelessHART™ protocol may share the application layer. The shared application layer may be used to provide the mapping between the two process control protocols.

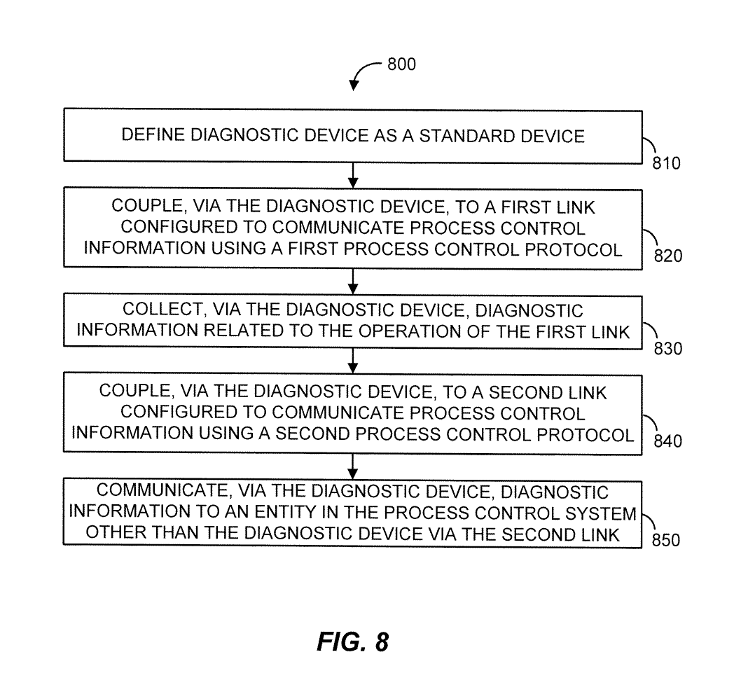

FIG. 8 is a flow chart illustrating an example diagnostic method 800 for use in a process control system, such as process control systems 200-400 illustrated in FIGS. 2-4, for example. The method 800 includes defining an integrated seamless diagnostic device (such as the integrated seamless diagnostic devices illustrated in FIGS. 2-7) as a standard device using EDDL (block 810). After the integrated seamless diagnostic device is defined, the method 800 includes communicatively coupling, via a diagnostic interface of the integrated seamless diagnostic device, to a first communication link in the process control system, where the first communication link is configured to communicate process control information using a first process control protocol (block 820). One example of a first process control protocol is the Fieldbus process control protocol.

The method 800 further includes collecting, via the diagnostic interface, diagnostic information related to the operation of the first communication link (block 830). Once the diagnostic information is collected, the method 800 includes communicatively coupling, via a communication interface of the diagnostic device, to a second communication link that is different from the first communication link, where the second communication link is configured to communicate information using a second process control protocol (block 840). As an example, the second process control protocol can be a HART® process control protocol, a WirelessHART™ process control protocol, or a combination thereof.

The method 800 further includes communicating, via the communication interface, data indicative of the collected diagnostic information to an entity in the process control system other than the diagnostic device (e.g., a controller, a workstation, and so on) via the second communication link and using the second process control protocol (block 850). Generally, the first process control protocol and the second process control protocol are different industrial automation protocols, and each process control protocol has specific mechanisms for communicating process control information.

Although the various example seamless integration techniques described above have been discussed in the context of diagnostics, it will be understood by one of ordinary skill in the art that the described techniques (and similar techniques) may be used in other contexts. For example, as will be described below, seamless integration techniques may be utilized to integrate different field devices that use different process control protocols into the same process control system.

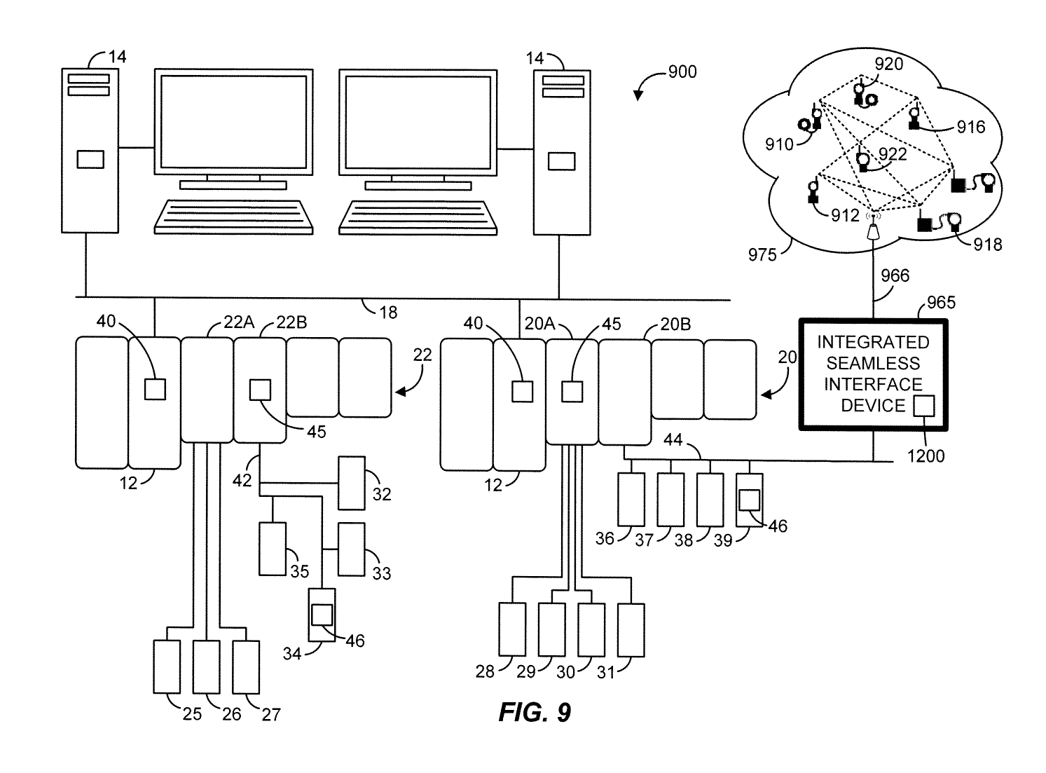

FIG. 9 is a block diagram illustrating an example process control system 900 that integrates different field devices that use different process control protocols. In order to integrate different field devices that use different process control protocols, the process control system 900 includes an integrated seamless interface device 965. Generally, the integrated seamless interface device 965 is used to collect process control information related to a measurement or a control of a physical process parameter via one communication link 966, and using one process control protocol, and to communicate the collected process control information to other entities in the process control system 900 via another communication link 44 that supports a different process control protocol. For example, in the embodiment illustrated in FIG. 9, process control information is collected using WirelessHART™ field devices 910-920 (coupled to a WirelessHART™ network 975) and communicated, e.g., to the controller 12, via the Fieldbus digital bus 44. As a result, the integrated seamless interface device 965 may allow existing process control systems that have Fieldbus networks (or Profibus networks) to effectively take advantage of WirelessHART™ with minimal or no change to the structure of the process control system. That is, from the perspective of the process control system, the integrated seamless interface device 965 may operate as a regular Fieldbus (or Profibus) field device.

Although in the embodiment illustrated in FIG. 9, process control information is collected using WirelessHART™ field devices 910-920 and communicated to the controller 12, via the Fieldbus digital bus 44, it will be understood by one of ordinary skill in the art that other combinations of process control protocols can be used. For instance, process control information may be collected using WirelessHART™ field devices 910-920 and communicated to the controller 12 via a Profibus communication link.

Depending on the combination of process control protocols used for collecting and communicating process control information, the integrated seamless interface device 965 may include appropriate protocol stacks. For example, in the embodiment illustrated in FIG. 9, the integrated seamless interface device 965 may include a protocol stack used by the Fieldbus (or Profibus) protocol and also a protocol stack used by the WirelessHART™ protocol. However, in some embodiments, the protocol stack used by the Fieldbus (or Profibus) protocol and the protocol stack used by the WirelessHART™ protocol may share the application layer. The shared application layer may be used to provide a mapping (e.g., parameter mapping) between the two process control protocols.

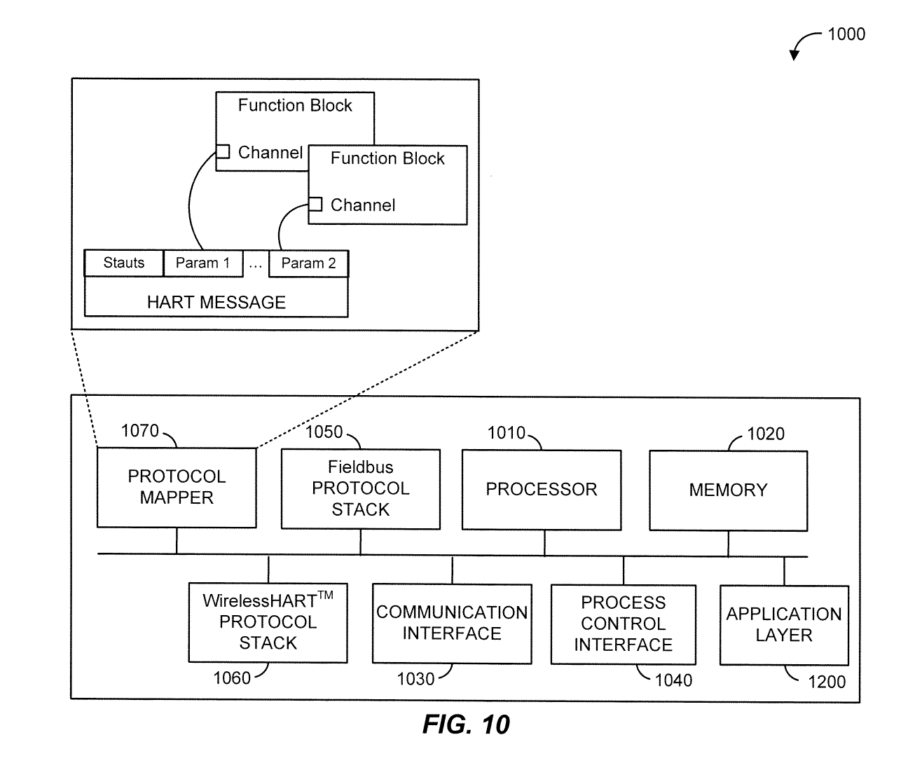

FIG. 10 is a block diagram illustrating an example architecture of an integrated seamless interface device 1000. Generally, the integrated seamless interface device 1000 includes a process control interface 1040 and a communication interface 1030. The process control interface 1040 is configured to communicatively couple to one communication link, and to use that communication link to collect (e.g., via a WirelessHART™ field device and/or network) process control information related to a measurement or a control of a physical process parameter. The communication interface 1030 is configured to communicatively couple to another communication link (e.g., a Fieldbus digital bus) to communicate data indicative of the collected process control information via that communication link to an entity in the process control system other than the integrated seamless interface device 1000.

Depending on the combination of process control protocols used for collecting and communicating diagnostic information, the integrated seamless interface device 1000 may include appropriate protocol stacks. For example, if used as the integrated seamless interface device 965 in the embodiment illustrated in FIG. 9, the integrated seamless interface device 1000 may include a Fieldbus protocol stack 1050 used by the Fieldbus (or Profibus) protocol and also a WirelessHART™ protocol stack 1060 used by the WirelessHART™ protocol. The integrated seamless interface device 1000 may also include a protocol mapper 1070 for providing a mapping (e.g., parameter mapping) between the two process control protocols. In some embodiments, the protocol stack used by the Fieldbus (or Profibus) protocol and the protocol stack used by the WirelessHART™ protocol may share the application layer. The shared application layer may be used to provide the mapping between the two process control protocols.

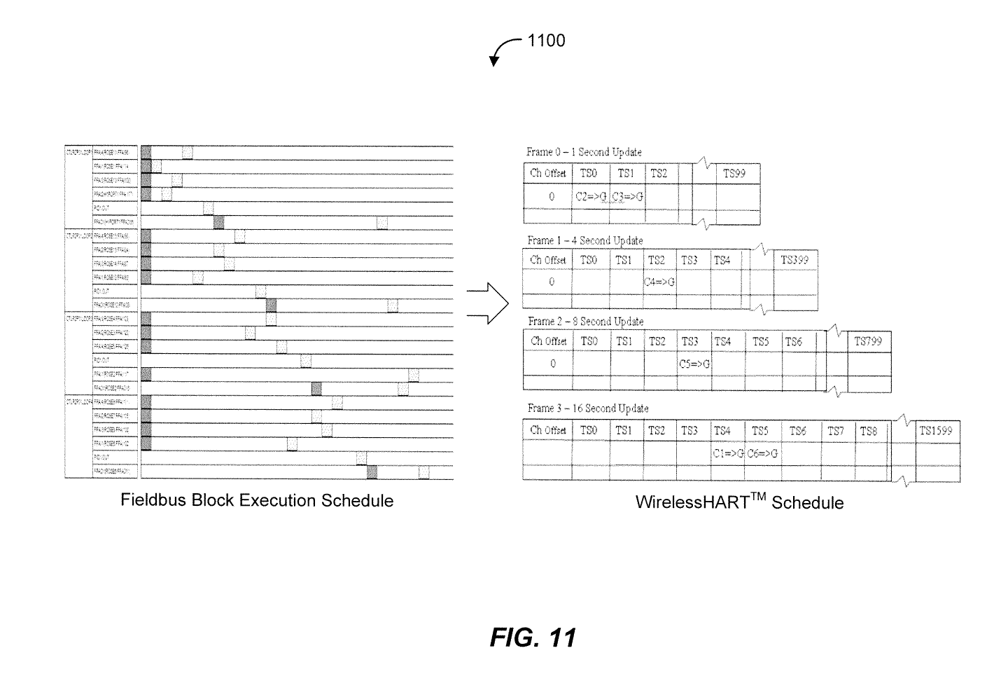

FIG. 11 a timing diagram illustrating an example mapping 1100 of parameters between the Fieldbus and the WirelessHART™ protocols. In some embodiments, parameters from the WirelessHART™ field devices may mapped in the integrated seamless interface device 1000 device to the Fieldbus function block application layer. From the perspective of the control system that includes the integrated seamless interface device 1000, the integrated seamless interface device 1000 installed in the field and attached through a fieldbus segment could be treated as regular a Fieldbus device that includes function blocks. The measurements or actuators associated with the WirelessHART™ field devices could be reflected in the FF IO blocks. Alarm detection may be done using the standard alarm features of the AI, DI, or PID blocks, as defined by the Fieldbus standard. In addition, PlantWeb Alerts may be set up for the integrated seamless interface device 1000 device and WirelessHART™ field devices connected to via the integrated seamless interface device 1000.

The communication channel and its association with the WirelessHART™ field device tags may be used by the appropriate protocol stack to associate a function block with a WirelessHART™ field device. Information required by Fieldbus and Profibus is available through parameters periodically communicated through HART commands. As an example of this, HART command 9 may contain status and up to eight device or dynamic parameters. These parameters can then be mapped to Fieldbus Function Blocks through the Fieldbus Function Block Channel parameter.

The network manager defined by the WirelessHART™ specification could reside in the integrated seamless interface device, such as the integrated seamless interface device 1000 illustrated in FIG. 10. Thus, it may be possible for the integrated seamless interface device to automatically create the superframes used in wireless communication. No user intervention may be required where the control system supports control in the field. The communication schedule that is required for the WirelessHART™ network management may be automatically generated in the integrated seamless interface device based on parameters that are written to the device by the control system. For example, the WirelessHART™ Schedule could be automatically generated from the Fieldbus Foundation or Profibus schedule that is downloaded to the integrated seamless interface device.

In this manner, it may be possible to synchronize the execution of the function blocks in the integrated seamless interface device with the measurements and output slot times supported by WirelessHART™ field devices. Additionally, or alternatively, for monitoring and calculation applications (or if the control system does not support control in the field), the schedule could be generated by the integrated seamless interface device from parameters that the control system writes to the resource block that define the communication requirements associated with the wireless application. If only a few WirelessHART™ field devices are supported by the integrated seamless interface device, scheduling may be comparatively simple, minimizes number of hops and the associated power consumption.

In some cases a WirelessHART™ field device may have various parameters that are used to setup, calibrate and diagnose the operation of the device. Rather than saving all of these parameters in the integrated seamless interface device, the integrated seamless interface device may be designed to allow HART commands communicated by the control system to the integrated seamless interface device to be automatically forwarded to the associated WirelessHART™ field device. Such pass-through communications may be used by asset management packages associated with the control system. Once these asset management applications support WirelessHART™, the changes required to support an integrated seamless interface device may be minor.

Generally speaking, any of the interface devices described herein may collect (which includes measuring, determining, detecting, generating otherwise obtaining) diagnostic information that defines or that is associated with a diagnostic condition associated with the communication link being monitored, e.g., a Fieldbus link, in any desired manner. Generally, the diagnostic interface may monitor one or more signals or data transmissions on the monitored communication link and may detect diagnostic conditions of the monitored communication link based on the content or quality or both of these signals. For example, the diagnostic interface may collect or determine diagnostic information in the form of one or more wiring errors present on the monitored communication link. Detecting these wiring errors may include identifying one or more of an incorrect wiring connection, an open circuit or a short circuit, an intermittent wiring connection or a reversed polarity in a wiring connection on the monitored communication link. Additionally or alternatively, the diagnostic interface may collect or determine diagnostic information in the form of an identification that there are too many or too few terminators on the monitored communication link based on the protocol requirements associated with the monitored communication link, may collect or determine diagnostic information in the form of an identification of a fault in a physical layer of another device connected to the monitored communication link or any other “out of the box” fault in one or more devices connected to the monitored link and/or may collect or determine diagnostic information in the form of an identification that there is/are one or more grounding errors present on the monitored communication link or that there is an absence of any clear grounding strategy on the monitored link. Of course, other types of diagnostic information may be collected or determined instead or as well.

In some cases, each of these types of diagnostic information may be determined by or from the quality of or based on some characteristic of signals present on the monitored communication link, including the rise and decay times of the signals on the monitored communication link, voltage or current levels of signals on the monitored communication link, the polarity or phase of the signals on the monitored communication link, etc. In fact, there are many known methods of detecting diagnostic conditions based on one or more characteristics or qualities of the signals on a communication link, and the diagnostic interface may implement any of these or other known techniques for detecting various diagnostic conditions based on the properties of signals present on or being monitored on the communication link.

In addition, the diagnostic interfaces described herein may store and execute one or more diagnostic applications therein, wherein these diagnostic applications may analyze a signal over time, or may analyze numerous different signals or data transmissions (e.g., associated with the same signal over time or different signals) present on the monitored communication link to determine one or more diagnostic conditions associated with the monitored communication link. For example, as illustrated in FIGS. 4-10, the diagnostic interface devices in these figures may store one or more applications 1200 or may have an application layers 1200 that implements one or more applications which analyze data or signals collected from the monitored communication link. In some cases, the applications 1200 may perform a power spectrum analysis on the process control information on the monitored link, which may include any signals on the monitored communication link. In one embodiment, the power spectrum analysis may by used to identify the different frequencies and their power contributions to a measured process control signal. This type of power spectrum analysis may be used to identify or to detect process noise within the process control signal (e.g., by detecting power at frequencies that should not have significant spectral contributions, etc.) For example, power at certain frequencies in a signal may be indicative of sloshing of a liquid in a tank. Of course, there are many other types of or examples of process noise that can be determined from the power spectrum of one or more signals on a monitored communication link.

Generally, in these cases, the diagnostic interface may store an application 1200 and may execute the application 1200 on a processor within to diagnostic interface device to determine the diagnostic information based on multiple pieces of data collected from the monitored communication link. As noted above, the application 1200 may perform a power spectrum analysis on the multiple pieces of data collected from the monitored communication link, may operate to detect noise of any desired type on the monitored communication link (e.g., noise indicative of an improperly grounded electrical apparatus) or may detect (e.g., determine) one or more performance indicators for the monitored communication link, wherein each of the one or more performance indicators indicates a quality or measurement of performance of communications on the monitored communication link. These performance indicators may include, for example, a communication error rate (on the monitored link), a bus utilization rate, communication delay times, etc.

At least some of the functionality of the various devices described above (and similar devices) may be implemented utilizing hardware, a processor (such as processor 710 in FIG. 7 and processor 1010 in FIG. 10) executing firmware instructions and/or software instructions, or any combination thereof. An example of an application that could be loaded into the firmware includes power spectrum analysis. By including power spectrum analysis in this way it is possible to detect process noise. In addition, having the analysis integrated in this way allows the diagnostic module to monitor for problems as the process is moved through its range of operation. When implemented utilizing a processor executing software or firmware instructions, the software or firmware instructions may be stored in any computer readable memory (e.g., memory 720 in FIG. 7 and memory 1020 in FIG. 10) such as on a magnetic disk, an optical disk, or other storage medium, in a RAM or ROM or flash memory, processor, hard disk drive, optical disk drive, tape drive, etc. Likewise, the software or firmware instructions may be delivered to a user or a system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software or firmware instructions may be delivered to a user or a system via a communication channel such as a telephone line, a DSL line, a cable television line, a fiber optics line, a wireless communication channel, the Internet, etc. (which are viewed as being the same as or interchangeable with providing such software via a transportable storage medium). The software or firmware instructions may include machine readable instructions that, when executed by the processor, cause the processor to perform various acts.

When implemented in hardware, the hardware may comprise one or more of discrete components, an integrated circuit, an application-specific integrated circuit (ASIC), etc.

Although the foregoing text set forth a detailed description of several example methods, devices and systems that may provide integrated seamless diagnostics in a process control environment, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. An interface device for use with a process control system, the process control system comprising a first communication link configured to communicate information using a first process control protocol, a second communication link that is different from the first communication link and is configured to communicate information using a second process control protocol, wherein at least one field device is coupled to the first communication link, the at least one field device configured to control or measure a physical process parameter, the interface device comprising:
a process control interface configured to communicatively couple to the first communication link to collect process control information related to a measurement or a control of the physical process parameter;
a diagnostic application that executes on the interface device to analyze the collected process control information to determine a diagnostic condition associated with the first communication link or a device communicatively coupled to the first communication link; and
a communication interface configured to communicatively couple to the second communication link to communicate the diagnostic condition via the second communication link and using the second process control protocol, to an entity in the process control system other than the interface device;
wherein the first process control protocol and the second process control protocol are different industrial automation protocols, each of the first process control protocol and the second process control protocol having specific mechanisms for communicating process control information.

2. The interface device of claim 1, wherein the first process control protocol supports wireless communication.

3. The interface device of claim 1, wherein the first process control protocol is a WirelessHART™ protocol.

4. The interface device of claim 1, wherein the second communication link is a Fieldbus digital bus, and wherein the second process control protocol is the Fieldbus process control protocol.

5. The interface device of claim 1, wherein the diagnostic application is executable to perform a power spectrum analysis on the process control information.

6. The interface device of claim 5, wherein the power spectrum analysis identifies different frequencies and their power contributions to a measured process control signal.

7. The interface device of claim 5, wherein the power spectrum analysis identifies different frequencies and their power contributions to a measured process control signal to detect process noise within the process control signal.

8. The interface device of claim 1, wherein the diagnostic application executes to detect noise on the first communication link based on the process control information.

9. The interface device of claim 1, wherein the diagnostic application executes to detect noise on the first communication link, the noise being indicative of an improperly grounded electrical apparatus.

10. The interface device of claim 1, wherein the diagnostic application executes to detect one or more performance factors associated with the first communication link based on based on the process control information.

11. The interface device of claim 10, wherein the one or more performance factors includes a communication error rate or a bus utilization rate.

12. A process control system comprising:
a first communication link configured to communicate process control information using a first process control protocol;
a second communication link that is different from the first communication link and is configured to communicate process control information using a second process control protocol; and
a diagnostic device including:
a diagnostic interface communicatively coupled to the first communication link and configured to collect or determine diagnostic information related to the operation of the first communication link; and
a communication interface communicatively coupled to the second communication link and configured to communicate data indicative of the collected diagnostic information, via the second communication link and using the second process control protocol, to an entity in the process control system other than the diagnostic unit.
wherein the first process control protocol and the second process control protocol are different industrial automation protocols, each of the first process control protocol and the second process control protocol having specific mechanisms for communicating process control information.

13. The process control system of claim 12, wherein the second communication link is a wireless link, and wherein the second process control protocol supports wireless communications.

14. The process control system of claim 13, wherein the second communication link includes a wireless gateway disposed between the communication interface and the entity in the process plant other than the diagnostic unit, and wherein the wireless gateway is configured to translate between the second process control protocol that supports wireless communications and a communication protocol that supports wired communications.

15. The process control system of claim 14, wherein the second communication link comprises a WirelessHART™ adaptor disposed between the diagnostic device and the wireless gateway, and wherein the WirelessHART™ adaptor is configured to translate between the HART® protocol and the WirelessHART™ protocol.

16. The process control system of claim 12, wherein the diagnostic device and the second communication protocol support the Highway Addressable Remote Transducer (HART®) protocol.

17. The process control system of claim 12, wherein the diagnostic device and the second communication protocol support the WirelessHART™ process control protocol.

18. The process control system of claim 12, wherein the diagnostic device is defined as a standard device using Electronic Device Description Language (EDDL).

19. The process control system of claim 12, wherein the diagnostic interface collects or determines diagnostic information in the form of one or more wiring errors present on the first communication link.

20. The process control system of claim 19, wherein the one or more wiring errors includes an identification of an incorrect wiring connection, or an open circuit or a short circuit, or an intermittent wiring connection or a reversed polarity in a wiring connection on the first communication link.

21. The process control system of claim 12, wherein the diagnostic interface collects or determines diagnostic information in the form of an identification that there are too many or too few terminators on the first communication link based on the protocol requirements associated with the first communication link.

22. The process control system of claim 12, wherein the diagnostic interface collects or determines diagnostic information in the form of an identification of a fault in a physical layer of another device connected to the first communication link.

23. The process control system of claim 12, wherein the diagnostic interface collects or determines diagnostic information in the form of an identification that there is one or more grounding errors present on the first communication link.

24. The process control system of claim 12, wherein the diagnostic interface executes an application to determine the diagnostic information based on multiple pieces of data collected from the first communication link.

25. The process control system of claim 24, wherein the application performs a power spectrum analysis on the multiple pieces of data collected from the first communication link.

26. The process control system of claim 24, wherein the application operates to detect noise on the first communication link.

27. The process control system of claim 24, wherein the application operates to detect one or more performance indicators for the first communication link, each of the one or more performance indicators indicating a quality of performance of communications on the first communication link.

28. A diagnostic device for use with a process control system, the process control system comprising a first communication link configured to communicate information using a first process control protocol and a second communication link that is different from the first communication link and is configured to communicate information using a second process control protocol, the diagnostic device comprising:
a diagnostic interface configured to communicatively couple to the first communication link to collect or generate diagnostic information related to the operation of the first communication link; and
a communication interface configure to communicatively couple to the second communication link to communicate data indicative of the collected diagnostic information, via the second communication link and using the second process control protocol, to an entity in the process control system other than the diagnostic device;
wherein the first process control protocol and the second process control protocol are different industrial automation protocols, each of the first process control protocol and the second process control protocol having specific mechanisms for communicating process control information.

29. The diagnostic device of claim 28, wherein the first communication link is a Fieldbus digital bus, and wherein the first process control protocol is a Fieldbus process control protocol.

30. The diagnostic device of claim 29, wherein the Fieldbus digital bus includes a power supply, and wherein the diagnostic interface is configured to communicatively couple to the power supply.

31. The diagnostic device of claim 28, wherein the second process control protocol is a HART® process control protocol or a WirelessHART™ process control protocol.

32. The diagnostic device of claim 28, wherein the second process control protocol is a combination of a HART® process control protocol and a WirelessHART™ process control protocol.

33. The diagnostic device of claim 28, wherein the diagnostic interface collects or determines diagnostic information in the form of one or more wiring errors present on the first communication link.

34. The diagnostic device of claim 33, wherein the one or more wiring errors includes an identification of an incorrect wiring connection, or an open circuit or a short circuit, or an intermittent wiring connection or a reversed polarity in a wiring connection on the first communication link.

35. The diagnostic device of claim 28, wherein the diagnostic interface collects or determines diagnostic information in the form of an identification that there are too many or too few terminators on the first communication link based on the protocol requirements associated with the first communication link.

36. The diagnostic device of claim 28, wherein the diagnostic interface collects or determines diagnostic information in the form of an identification of a fault in a physical layer of another device connected to the first communication link.

37. The diagnostic device of claim 28, wherein the diagnostic interface collects or determines diagnostic information in the form of an identification that there is one or more grounding errors present on the first communication link.

38. The diagnostic device of claim 28, wherein the diagnostic interface executes an application to determine the diagnostic information based on multiple pieces of data collected from the first communication link.

39. The diagnostic device of claim 38, wherein the application performs a power spectrum analysis on the multiple pieces of data collected from the first communication link.

40. The diagnostic device of claim 38, wherein the application operates to detect noise on the first communication link.

41. The diagnostic device of claim 38, wherein the application operates to detect one or more performance indicators for the first communication link, each of the one or more performance indicators indicating a quality of performance of communications on the first communication link.

42. A diagnostic method for use in a process control system, the method comprising:
communicatively coupling, via a diagnostic interface of a diagnostic device, to a first communication link in the process control system, wherein the first communication link is configured to communicate process control information using a first process control protocol;
collecting, via the diagnostic interface, diagnostic information related to the operation of the first communication link;
communicatively coupling, via a communication interface of the diagnostic device, to a second communication link that is different from the first communication link, wherein the second communication link is configured to communicate information using a second process control protocol; and
communicating, via the communication interface, data indicative of the collected diagnostic information to an entity in the process control system other than the diagnostic device via the second communication link and using the second process control protocol;
wherein the first process control protocol and the second process control protocol are different industrial automation protocols, each of the first process control protocol and the second process control protocol having specific mechanisms for communicating process control information.

43. The method of claim 42, further comprising defining the diagnostic device as a standard device using Electronic Device Description Language (EDDL).

44. The method of claim 42, wherein the second communication link is a wireless link, and wherein the second process control protocol supports wireless communications.

45. The method of claim 42, wherein collecting diagnostic information related to the operation of the first communication link includes monitoring one or more signals on the first communication link and determining the diagnostic information as a diagnostic condition of the first communication link based on the one or more monitored signals.

46. The method of claim 45, wherein determining the diagnostic information as a diagnostic condition of the first communication link includes determining the diagnostic information in the form of detecting one or more wiring errors present on the first communication link.

47. The method of claim 46, wherein the one or more wiring errors includes an identification of an incorrect wiring connection, or an open circuit or a short circuit, or an intermittent wiring connection or a reversed polarity in a wiring connection on the first communication link.

48. The method of claim 45, wherein determining the diagnostic information as a diagnostic condition of the first communication link includes determining the diagnostic information in the form of an identification that there are too many or too few terminators on the first communication link based on the protocol requirements associated with the first communication link.

49. The method of claim 45, wherein determining the diagnostic information as a diagnostic condition of the first communication link includes determining the diagnostic information in the form of an identification of a fault in a physical layer of another device connected to the first communication link.

50. The method of claim 45, wherein determining the diagnostic information as a diagnostic condition of the first communication link includes determining the diagnostic information in the form of an identification that there is one or more grounding errors present on the first communication link.

51. The method of claim 45, wherein determining the diagnostic information as a diagnostic condition of the first communication link includes executing an application in the diagnostic interface to determine the diagnostic information based on multiple pieces of data collected from the first communication link.

52. The method of claim 51, wherein executing the application includes performing a power spectrum analysis on the multiple pieces of data collected from the first communication link.

53. The method of claim 51, wherein executing the application includes analyzing the multiple piece of data collected from the first communication link to detect noise on the first communication link.

54. The method of claim 51, wherein executing the application includes analyzing the multiple piece of data collected from the first communication link to determine one or more performance indicators for the first communication link, each of the one or more performance indicators indicating a quality of performance of communications on the first communication link.
